(19) United States
(12) Patent Application Publication
(10) Pub. No.: US 2009/0012965 A1
(43) Pub. Date: Jan. 8, 2009

(54) Network Content Objection Handling System and Method

(75) Inventor: Kenneth A. Franken, Iowa City, IA (US)

Correspondence Address: DOWNS RACHLIN MARTIN PLLC, 199 MAIN STREET, P O BOX 190, BURLINGTON, VT, 05402-0190, US

(73) Assignee: DECISIONMARK CORP., Cedar Rapids, IA (US)

(21) Appl. No.: 12/164,695

(22) Filed: Jun. 30, 2008

Related U.S. Application Data
(60) Provisional application No. 60/947,434, filed on Jul. 1, 2007.
(60) Provisional application No. 60/983,932, filed on Oct. 30, 2007.

(51) Int. Cl. G06F 17/30

(52) U.S. Cl. 707/10; 707/E17.032

(57) ABSTRACT

A system and method for distribution of one or more content items to one or more users over a network, such as the Internet. One or more users that access a content item may provide an indication of objection to the content item. The content item may be flagged for manual review when a first threshold percentage of indications of objection is met. The content item is automatically removed from distribution when a second threshold percentage of indications of objection is met and a threshold number of instances of access is met.

### RELATED APPLICATION DATA

This application claims the benefit of priority of U.S. Provisional Patent Application Ser. No. 60/947,434, filed Jul. 1, 2007, and titled “Network Content Objection Handling System and Method” and U.S. Provisional Patent Application Ser. No. 60/983,932, filed Oct. 30, 2007, and titled “Network Content Objection Handling System and Method,” each of which is incorporated by reference herein in its entirety.

### FIELD OF THE INVENTION

The present invention generally relates to the field of network communication. In particular, the present invention is directed to a network content objection handling system and method.

### BACKGROUND

Computing device users are increasingly accessing more content items over one or more networks, such as the Internet. For example, on the Internet, websites abound for downloading and/or streaming video and song content items to computing devices, both mobile and fixed. Additionally, with the massive amount of content items posted for access on the Internet, it has become very difficult to control the qualitative aspects of the content. Oftentimes a website operator may allow third-party business entities and individuals to upload and/or link their own content to the website of the operator. The operator of the website may not have an opportunity to review the content prior to its posting. Users of content items on networks, particularly on the Internet, will likely access content items for which they find one or more elements of the content objectionable. It is desirable to have systems and methods for dealing with user objection to content items on a network.

### SUMMARY OF THE DISCLOSURE

In one embodiment, a computer-implemented method for removing a potentially objectionable content item from distribution over a network is provided. The method includes providing an interface over the network allowing access to a first content item to a plurality of users; allowing one or more of the plurality of users to provide an indication of objection to the first content item via the interface; receiving one or more indications of objection from one or more of the plurality of users that access the first content item; determining an objecting percentage of the users that access the first content item that provide an indication of objection; flagging the first content item for manual review when the objecting percentage meets a first threshold percentage; and automatically removing the first content item from distribution via the interface when the objecting percentage meets a second threshold percentage and the total number of instances of access of the first content item meets a third threshold number.

In another embodiment, a computer-implemented method for removing a potentially objectionable content item from distribution via a network interface is provided. The method includes providing access to a first content item via an interface over the network; recording information corresponding to each instance of access of the first content item; receiving one or more indications of objection to the first content item; determining an objecting percentage of the instances of access that involve a corresponding indication of objection; flagging the first content item for manual review when the objecting percentage meets a first threshold percentage; and automatically removing the first content item from distribution via the interface when the objecting percentage meets a second threshold percentage and a total number of instances of access meets a third threshold number.

In yet another embodiment, a machine-readable medium containing machine executable instructions implementing a method for removing a potentially objectionable content item from distribution via a network interface is provided. The instructions include a set of instructions for providing an interface over the network allowing access to a first content item to a plurality of users; a set of instructions for allowing one or more of the plurality of users to provide an indication of objection to the first content item via the interface; a set of instructions for receiving one or more indications of objection from one or more of the plurality of users that access the first content item; a set of instructions for determining an objecting percentage of the users that access the first content item that provide an indication of objection; a set of instructions for flagging the first content item for manual review when the objecting percentage meets a first threshold percentage; and a set of instructions for automatically removing the first content item from distribution via the interface when the objecting percentage meets a second threshold percentage and the total number of instances of access of the first content item meets a third threshold number.

In still another embodiment, a system for removing a potentially objectionable content item from distribution via a network interface. The system includes means for providing an interface over the network allowing access to a first content item to a plurality of users; means for allowing one or more of the plurality of users to provide an indication of objection to the first content item via the interface; means for receiving one or more indications of objection from one or more of the plurality of users that access the first content item; means for determining an objecting percentage of the users that access the first content item that provide an indication of objection; means for flagging the first content item for manual review when the objecting percentage meets a first threshold percentage; and means for automatically removing the first content item from distribution via the interface when the objecting percentage meets a second threshold percentage and the total number of instances of access of the first content item meets a third threshold number.

In still yet another embodiment, a computer-implemented method for removing a content item from distribution over a network is provided. The method includes providing an interface over the network allowing access to a first content item to a plurality of users; allowing one or more of the plurality of users to provide an indication of negative feedback to the first content item via the interface; flagging the first content item for manual review when a first threshold percentage of users that have accessed the first content item provide an indication of negative feedback to the first content item; and automatically removing the first content item from distribution via the interface when a second threshold percentage of users that access the first content item provide the indication of negative feedback and a first threshold number of instances of access of the first content item is met.

In a further embodiment, a computer-implemented method for removing a content item from distribution over a network is provided. The method includes providing an interface over the network allowing access to a first content item to a plurality of users; allowing one or more of the plurality of users to provide an indication of negative feedback to the first content item via the interface; flagging the first content item for manual review when a first threshold percentage of users that have accessed the first content item provide an indication of negative feedback to the first content item; and automatically removing the first content item from distribution via the interface when a second threshold percentage of users that access the first content item provide the indication of negative feedback and a first threshold number of users that access the first content item provide the indication of negative feedback.

In still a further embodiment, a method for pulling a content item from distribution over the Internet is provided. The method includes providing an interface over the Internet allowing access to a first content item to a plurality of users; allowing the plurality of users to provide an indication of negative feedback via the interface, the indication representing an individual user's negative reaction to the first content item; flagging the first content item for manual review when a first percentage of users that access the first content item provide the indication of negative feedback; and automatically removing the first content item from distribution via the interface when a second percentage of users that access the first content item provide the indication of negative feedback and a first threshold number of users that access the first content item provide the indication of negative feedback, wherein the second percentage is greater than the first percentage.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one embodiment of a method for removing a content item from distribution over a network;

FIG. 2 illustrates one embodiment of an interface for allowing access to one or more content items over a network;

FIG. 3 illustrates one embodiment of an interface for allowing a user to provide an indication of an objection to a content item accessed over a network;

FIG. 4 illustrates one embodiment of a system for removing a content item from distribution over a network;

FIG. 5 illustrates another embodiment of a system for removing a content item from distribution over a network;

FIG. 6 illustrates another embodiment of a method for removing a content item from distribution over a network;

FIG. 7 illustrates an exemplary computing device environment for use with one or more components of a system and/or method for removing a content item from distribution over a network;

FIG. 8 illustrates one example of an administrative interface;

FIG. 9 illustrates an exemplary view of one implementation of an administrative interface;

FIG. 10 illustrates another exemplary view of the administrative interface of FIG. 9;

FIG. 11 illustrates yet another exemplary view of the administrative interface of FIG. 9;

FIG. 12 illustrates one example of a content edit interface;

FIG. 13 illustrates one example of a metrics interface; and

FIG. 14 illustrates one example of an interface for configuring a setting of a content item and/or content item distribution system.

### DETAILED DESCRIPTION

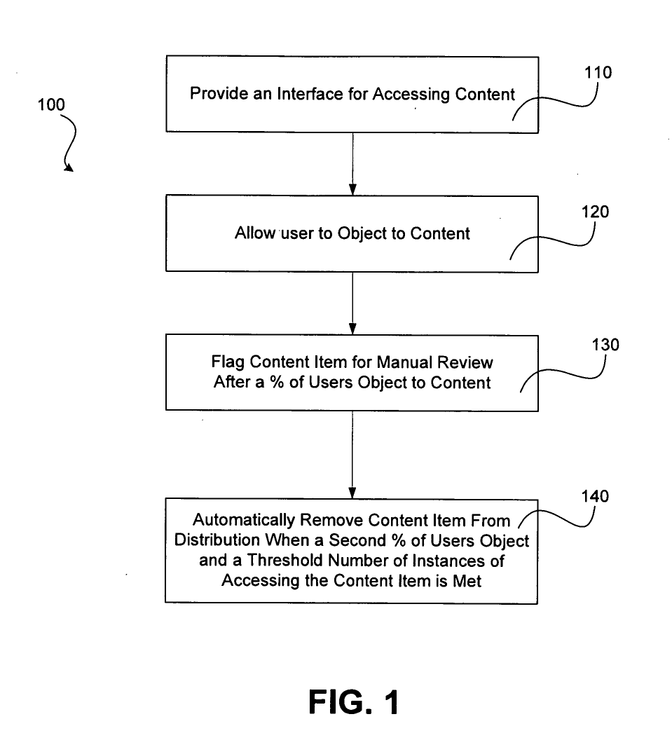

A system and method for removing a content item from distribution over a network is provided. FIG. 1 illustrates one implementation 100 of a method for removing a content item from distribution over a network. At stage 110, an interface for accessing one or more content items is provided to one or more users of a computer network. At stage 120, a user of the interface is given an opportunity to provide an indication of one or more objections to a content item accessed via the interface. At stage 130, the content item is flagged for manual review when a threshold percentage is met of users that have accessed the first content item that have also provided an indication of objection to the content item. At stage 140, the content item is automatically removed from distribution when a second threshold percentage of users that have provided an indication of objection to the content item is met and a threshold number of instances of accessing the content item is also met. Stages 110 to 140 and exemplary aspects thereof are discussed further below.

A discussed above, at stage 110, an interface for accessing one or more content items is provided to a one or more users of a computer network. As discussed further below, a computer network may include one or more delivery systems for providing direct or indirect communication between two or more computing devices, irrespective of physical separation of the computing devices. Examples of a network include, but are not limited to, a wide area network (e.g., the Internet, an enterprise network), a local area network (e.g., a network associated with an office, a building, a campus and/or other relatively small geographic space), a telephone network, a television network, a cable network, a radio network, a satellite network, a direct connection between two computing devices, and any combinations thereof. A network may employ a wired and/or a wireless mode of communication. In general, any network topology may be used. The Internet may be utilized herein in an exemplary fashion, however, distribution of a content item is not limited to use of the Internet.

A variety of types of content items may be distributed over a network. Examples of a content item include, but are not limited to, a video item, an audio item, an audio/visual item, a static visual item (e.g., a picture), a computer program, a web page or portion thereof, and any combinations thereof. In one example, a video content item (which may also include audio) is accessible over a network, such as the Internet, via a provided interface. Various interfaces are contemplated for providing access to a content item over a network. In one example, the configuration and/or functionality of a particular interface may depend on the type of content item to be accessed. In another example, the configuration and/or functionality of an interface may be dictated by the desires of the targeted users.

At stage 120, a user of the interface is given an opportunity to provide an indication of one or more objections to a content item accessed via the interface. This opportunity may be provided to the user as a functionality of the interface. The interface may be configured to allow a user to provide an objection report to an operator of the interface and/or to a provider of the content item objected to by the user. Exemplary ways of allowing an opportunity to a user to provide an indication of one or more objections include, but are not limited to, a link, a comment entry element, a toggle, a button, an audio entry element, and any combinations thereof. In one example, a user is provided with a clickable link and/or button for indicating an objection to a content item accessed via an interface. In another example, a user is provided with a clickable link and/or button that accesses a displayable element of an interface that allows the user to provide an indication of an objection to a content item.

Objection to a content item may depend on the individual user accessing the content item. The type of objection is not meant to be limited in any way. The types and levels of objection may be dictated by the type of content, the environment of distribution, the target recipient of the content, the projected lifetime of the content, privacy concerns, potential for reuse of the content, violations of law, and/or one or more other factors. Example types of objection include, but are not limited to, a user finding a content item offensive, a user representing a breach of personal privacy by the content, a user alleging that the content violates a law, a user representing that the content is inappropriate for the site (but not necessarily offensive), a user representing that the content item does not match the user's personal tastes (e.g., likes and dislikes), and any combinations thereof. An indication of an objection to a content item may be categorized. A variety of categories are contemplated. Exemplary categories for an objection include, but are not limited to, a sexually explicit category, a violent content category, a mature content category, a hate speech category, an inappropriate content category, an “other” category, a copyright violating content category, and any combinations thereof.

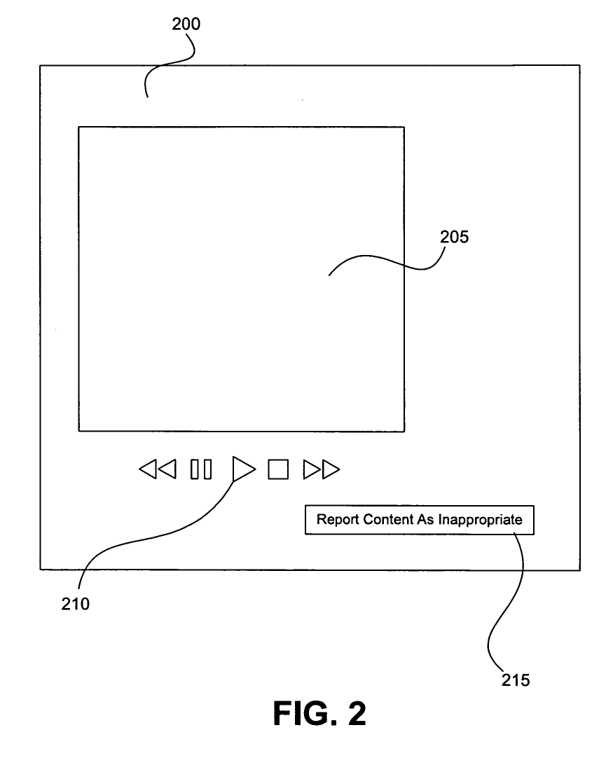

FIG. 2 illustrates one example of an interface 200 for providing access to a content item, such as a video content item. Interface 200 includes a display region 205 for displaying a content item accessed by a user. Interface 200 also includes controls 210 for manipulating the accessed content item (e.g., rewind, pause, play, stop, and forward, respectively). A link 215 allows a user of interface 200 to indicate an objection to a content item displayed by display region 205. In one example, a user may indicate a general objection by simply selecting link 215 with a selection device (e.g., a computer mouse device). In another example, selecting link 215 causes an additional displayable element to be displayed to the user for providing one or more indications of an objection to a content item.

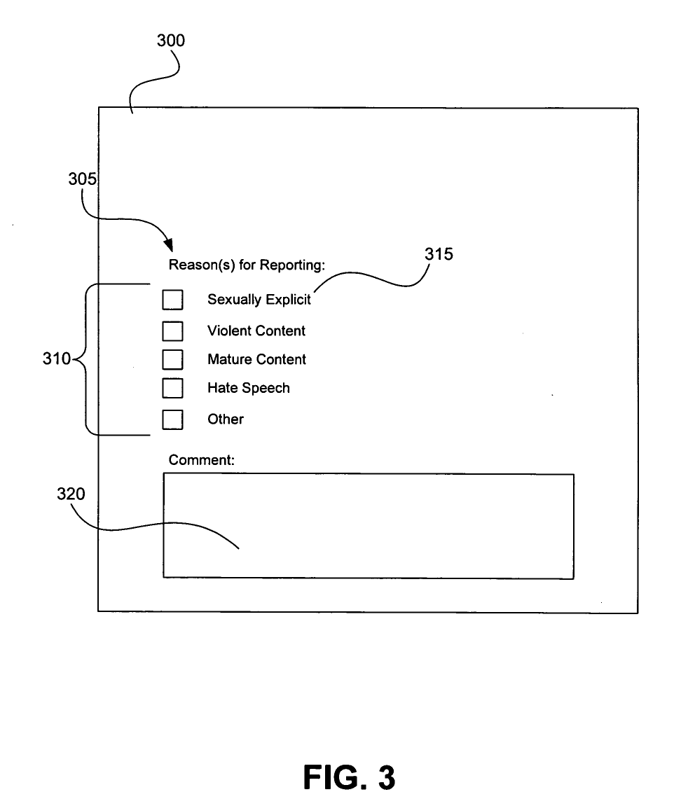

FIG. 3 illustrates one example of an additional displayable element 300 for allowing a user to enter one or more indications of an objection to a content item. Displayable element 300 includes a first region 305 for providing one or more reasons for reporting an dobjection. First region 305 includes check boxes 310 with labels 315. In one example, a user may select a single reason for objection by selecting one of check boxes 310 having a label 315 corresponding to a reason for their objection to a content item. In another example, a user may select a plurality of check boxes 310 having labels 315 corresponding to a plurality of reasons for their objection to a content item. Displayable element 300 also includes an optional second region 320 for providing one or more comments related to an objection to a content item. In one example, one or more comments may include a textual description of a reason for objection.

Referring again to FIG. 1 at stage 130, method 100 includes flagging the objected to content item for manual review when a first threshold percentage is met of users that have accessed the first content item that have also provided an indication of objection to the content item. A threshold percentage may be configured in a variety of ways. In one example, a threshold percentage may be configured such that it is met when the percentage of users that have objected to a content item is equal to the threshold percentage. In one such example, where the threshold is set at 10 percent (%) a content item is flagged for manual review when 10% of the users that have accessed the content item have provided an indication of objection to the content item. In another example, a threshold percentage may be configured such that it is met when the percentage of users that have objected to a content item is greater than the threshold percentage. In one such example, where the threshold is set at 10% a content item is flagged for manual review when greater than 10% of users that have accessed the content item have provided an indication of objection to the content item. Any percentage may be utilized as a first threshold percentage. The value of a first threshold percentage may depend on a variety of factors. Examples of such factors include, but are not limited to, an audience for the content, a rating of the content item, the amount of traffic to the site, a geographic location of a user, a geographic location of a content distribution site owner, a type of content distribution site (e.g., a site of a television broadcaster; an online classified site, such as CRAIGSLIST.ORG), and any combinations thereof. In one example, a first threshold percentage is 8%. In another example, a first threshold percentage is 25%.

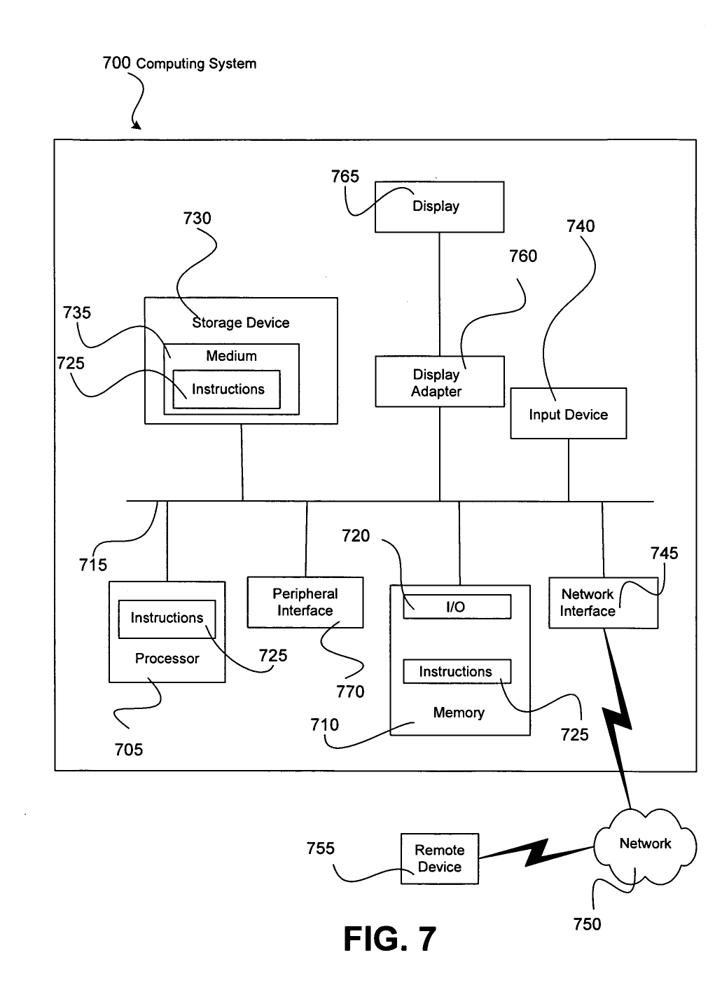

In one exemplary aspect, a percentage of users that object may require that the number of indications of objection by users and the total number of instances of accessing of a content item by users be known. Indications of objection by users may be tracked in a variety of ways. Example ways of tracking an indication of objection to a content item include, but are not limited to, incrementing an objection counter associated with the content item, entering a record in a database, modifying metadata associated with the content item, adding a line or entry to a log file, modifying an entry in a file, updating a value stored in memory, and any combinations thereof. In one example, one or more indications of objection may be tracked by generating a record in a database for each indication of objection. Example databases include, but are not limited to, a table, a relational database management system, an embedded database engine, an in-memory database, an object database, and any combinations thereof. In one example, a database may exist as part of and/or be stored in a machine-readable medium. Examples of a machine-readable medium are discussed further below with respect to FIG. 7. An objection record in a database may include a variety of data. Example data of an objection record include, but are not limited to, an identifier of a content item associated with an objection, an identifier of a user providing an objection, an indicator of a time and/or date related to the provision of the objection by a user, an identifier of an interface utilized by a user to access a content item, an identifier of information associated with the objection, a serialized representation of a programmatic “objection” object, and any combinations thereof. Example data of information associated with the objection may include, but are not limited to, one or more types of objection, a comment associated with the objection, and any combination thereof.

Multiple indications of objection by the same user for the same content item may be handled in a variety of ways. In one example, multiple indications of objection by the same user count as one objection. To assist in determining if the same user is providing multiple objections, an identification of a user may be monitored. An identity of a particular user may be monitored in a variety of ways. Exemplary ways to monitor an identity of a user include, but are not limited to, a user login, a user profile, a cookie on a computer of a user, an Internet Protocol (IP) address associated with a user, a media access control (MAC) address associated with a computing device of a user, an application URL (Universal Resource Locator) that contains information unique to a user, and any combinations thereof. In another example of tracking multiple indications of objection by a user, the multiple indications of objection by the same user are not limited to being counted as one objection. In one such example, each indication of objection is treated as a separate indication of objection.

In an alternate embodiment, different categories of objection may be given different weights toward the percentage of user objections. In one such example, an objection categorized as “sexually explicit” may be weighed heavier in calculations than an objection categorized as “vulgar language.” In one exemplary weighting implementation, a simple percentage of instances of objection may be replaced with a “synthetic” percentage derived by using the weights associated with individual objections to modify the simple percentage. Weighting factors may be assigned to each category of objection (e.g., the “sexually explicit” and “vulgar language” categories used in the above example). A weighting factor may take a variety of forms and have any value (e.g., a value that fits a desired weighting scheme). Forms for a weighting factor include, but are not limited to, a ratio factor (e.g., 1.0, 2.0, 0.25, 3.0, etc.), a percentage factor, and an absolute factor. In one exemplary aspect, varying weighting factors may provide similar functionality as varying threshold values assigned to one or more categories of objection. In another exemplary aspect, it is possible that an example “synthetic” percentage may have a value above 100%.

Weighting factors may be utilized to modify the percentage of instances of objection in a variety of ways. In one example, a “synthetic” percentage of users providing an indication of objection is calculated by summing the weighted indications of objection and dividing by the number of instances of accessing the content item. For example, such a “synthetic” percentage may be calculated as ([number of objections in first category]*[weighting factor for first category]+ . . . [number of objection nth category]*[weighting factor for nth category])/[number of instances of accessing content item]. In one such example, a “sexually explicit” category may have a weight of 3.0 and a “vulgar language” category may have a weight of 2.0. If for 50 instances of accessing the corresponding content item, 4 users provided an indication of objection to the content item based on the “vulgar language” category, 2 users provided an indication of objection based on the “sexually explicit” category, and 3 users provided an indication of objection based on both the “sexually explicit” and “vulgar language” categories, a “synthetic” percentage could be calculated as (4*2.0+2*3.0+3*(3.0+2.0)/2)/50=43%. In this example, the weights for objections in multiple categories (e.g., both “sexually explicit” and “vulgar language”) were averaged. Alternative methods for dealing with such multiple category objection may also be employed. In one example, the weighted objections for multiple categories could be summed separately (e.g., for the above example of 3 multiple category objections, the associated weighted objections could be summed as 3*3.0+3*2.0).

The number of users accessing a content item may be tracked in a variety of ways. Examples of ways to track the number of users accessing a content item include, but are not limited to, incrementing a hit counter associated with the content item, entering a record in a database, modifying metadata associated with the content item, adding a line or entry to a log file, modifying an entry in a file, updating a value stored in memory, and any combinations thereof. In one example, a record that can be utilized to track the total number of users is entered in a database for each instance of accessing of a content item. A record in a database associated with an accessing of a content item may include any of a variety of data. Examples of such data include, but are not limited to, an identifier of a content item accessed, an identifier of a user that accessed a content item, an indication of the amount of a content item actually accessed by a user (e.g., an amount of a video watched by a user), an indication of a time and/or date associated with the accessing of a content item, an identifier of an interface utilized by a user to access a content item, an identifier of content associated with the current content item (e.g., an advertisement associated with the content), a serialized representation of a programmatic “content access” object, and any combinations thereof. The amount of a content item actually accessed (e.g., an amount of an item that is actually viewed, listened to, downloaded, etc.) by a user may optionally be used to determine whether a given accessing of a content item is counted as a user accessing the content item for objection percentage calculations. In one example, a predetermined amount of a content item is required to be accessed by a user before the accessing is counted as an accessing of the content item. In one such example, the required amount of the content item accessed is about 100%. In another such example, the required amount of the content item accessed is an amount that is less than the whole of the content item. In still another such example, the required amount of the content item accessed is any amount greater than a fixed percentage of the content item.

Unique users that have accessed a given content item may be tracked in a variety of ways. Many ways of tracking unique users of a network resource are well known. Example ways of tracking unique users accessing a content item include, but are not limited to, a user login, a user profile, a cookie on a computer of a user, an Internet Protocol (IP) address associated with a user, a media access control (MAC) address associated with a computing device of a user, an application URL that contains information unique to a user, and any combinations thereof. In one example, the total number of unique users to access a content item (e.g., discounting multiple accessing of the same content item by the same user) may be utilized in determining a percentage of users that have objected to a content item. In one such example, the number of objections by unique users and the total number of unique users to access the content item are utilized. In another example, the number of objections by unique users and the total number of non-unique users to access the content item are utilized. In yet another example, multiple accessing instances by a single user of a given content item may count as an instance that increments the total number of accessing instances.

As discussed above in relation to stage 130, when a first threshold percentage of users that have objected to a content item is met, the content item is flagged for manual review to determine if the content item should be removed from distribution over the network. Flagging a content item for manual review may occur in a variety of ways. In one example, metadata associated with a content item is modified to indicate that the content item should be manually reviewed. In another example, an identifier of the content item is added to a database table that enumerate items to be manually reviewed. In yet another example, an identifier of the content item is appended to a file that lists items to be manually reviewed.

At stage 140, a content item is automatically removed from distribution when a second threshold percentage is met of users that have provided an indication of objection to a content item and a threshold number of instances of accessing the content item is also met.

Any percentage may be utilized as a second threshold percentage. In one example, a second threshold percentage is greater than a first threshold percentage for flagging a content item for manual review. In another example, a second threshold percentage is less than a first threshold percentage for flagging a content item for manual review. In yet another example, a second threshold percentage is equal to a first threshold percentage for flagging a content item for manual review. The value of a second threshold percentage may depend on a variety of factors. Examples of such factors include, but are not limited to, an audience for the content, a rating of the content item, the amount of traffic to the site, a value of the first threshold value, a geographic location of a user, a geographic location of a content distribution site owner, a type of content distribution site (e.g., a site of a television broadcaster; an online classified site, such as CRAIGSLIST.ORG), and any combinations thereof. In one example, a second threshold percentage has a value of 15%. In another example, a second threshold percentage has a value of 30%. In yet another example, a second threshold has a value of twice the first threshold value. In still another example, a second threshold has a value that is the same as the first threshold value.

Any number of total user instance of access may be utilized as a threshold number in combination with a second threshold percentage to be met for automatic removal of a content item from distribution. The value of a such a threshold number may depend on a variety of factors. Examples of such factors include, but are not limited to, an audience for the content, a rating of the content, an amount of traffic to the interface, a geographic location of a user, a geographic location of a content distribution site owner, a type of content distribution site (e.g., a site of a television broadcaster; an online classified site, such as CRAIGSLIST.ORG), and any combinations thereof. In one example, a threshold number of instances of accessing a content item may be based on the number of instances of accessing a corresponding one or more content items by any number of users that have accessed the one or more content items. In one such example, a threshold number of instances of access can be set to limit automatic removal of a content item to occur only when a certain total number of instances of accessing the content item has occurred, regardless of the percentage of objecting users. In another example, a threshold number of instances of accessing a content item may be based on the number of instances of accessing a corresponding one or more content items by users that have provided an indication of objection to the one or more content items. In one such example, automatic removal from distribution of a content item occurs when a second threshold percentage is met of users that have provided an indication of objection to the content item and a threshold number of instances of providing an indication of objection is also met. For example, a threshold number can be set that limits a content item from being removed from distribution to occur only when a certain total number of instances of objection have occurred, regardless of the percentage of objecting users. For exemplary purposes, the discussion herein may refer to number of instances of accessing a content item and a threshold number of instances of accessing a content item that are based on the total number of instances of access. It is contemplated that the number of instances of accessing a content item and a threshold number of instances of accessing a content item (as described herein) may also be based on other variations (e.g., less than the total number of instances of accessing and/or the number of instances of access that also correspond with an indication of objection).

Automatic removal from distribution may occur in a variety of ways. Example ways to automatically remove a content item from distribution include, but are not limited to, deletion of the content item, marking the content item (e.g., by modifying metadata associated with the content item) with an indication that the content item has been removed from distribution, adding the content to a list of content that should not be distributed, removing the content from a list of content that is allowed to be distributed, and any combinations thereof. In one example, a content item is automatically marked with an indication that the content item has been removed from distribution. In another example, one or more elements of metadata associated with a content item is automatically modified with an indication that the content item has been removed from distribution.

A content item that has been automatically removed from distribution but not deleted can be handled in a variety of ways. In one example, a content item that has been automatically removed from distribution may be flagged for manual review to determine if the removal from distribution is appropriate (e.g., whether the content item violates one or more policies of the administrator of the access interface and/or the provider of the content item). In another example, the content item may be referred to the provider of the content item (e.g., where the operator of the access interface is not the original provider of the content item. In one such example, a referral may include a communication to the content provider indicating that the content item was removed from distribution. In yet another example, the content item may remain, but not be accessible by a user. In one such example, provision of an interface for access includes a routine that suppresses from display and/or access any content item that has been removed from distribution. In another such example, a content item may be restricted from access by any one or more users that have provided an indication of objection to that content item, while allowing access to one or more users that have not provided an indication of objection to that content item.

Manual review typically involves one or more people (e.g., an administrator associated with the provision of the content item) accessing the content item to determine if the content item should be removed from distribution. One or more standards for reviewing the content item may be utilized in the determination process. Such standards may depend on a variety of factors including, but not limited to, a category of the content item, a rating associated with a content item, one or more policies of a provider of a content item, a number of complaints associated with a content item, an age of a content item, a geographic location of a user, a geographic location of a content distribution site owner, a type of content distribution site (e.g., a site of a television broadcaster; an online classified site, such as CRAIGSLIST.ORG), and any combinations thereof.

Manual and/or automatic removal from distribution of a content item may include removal from one or more levels of distribution. In one example, removal of a content item from distribution includes removal from distribution to all users. In another example, removal of a content item from distribution includes removal from distribution to one or more users that are less than all users. In one such example, a content item may be removed from distribution via a particular category or other distribution mechanism. In another such example, a content item may be removed from distribution via one or more interfaces, but remain available for distribution via one or more other interfaces (e.g., a content item may be removed from distribution over the interface that received one or more indications of objection, while remaining available for distribution on another interface of the same system). In yet another such example, a content item may be removed from distribution via a “featured items” listing.

In an alternate embodiment, a single piece of content may be shared by multiple distributors. In one example, one or more of the multiple distributors may share a single standard. The manual review may be done by any one of the distributors and automatically applied to all distributors. In another example, multiple distributors have different standards of review. In another example, each distributor may have a different set of standards for review. The manual review may be performed separately by each distributor and items flagged for removal by one distributor may still be made available for distribution by other distributors. For example, a set of distributors may serve different geographic areas, each having a distinct set of community standards. In this case, removal of a content item for one geographic area would have no effect on distribution to other geographic areas. Extension of this concept to distribution arrangements other than geographically distinct arrangements is straightforward.

Manual review may occur at any time in relation to the first threshold being met for a content item. In one example, flagged content items are periodically manually accessed for review. In another example, flagged content items are queued for manual review. In yet another example, a flagged content item is manually reviewed substantially near in time to when the content item is flagged. In still another example, a notification is sent to a reviewer when a content item is flagged, notifying the reviewer that flagged content is awaiting review.

If manual review results in a determination that a content item should be removed from distribution, such removal may occur in a variety of ways. Example ways to remove a content item from distribution include, but are not limited to, deletion of the content item, marking the content item (e.g., by modifying metadata associated with the content item) with an indication that the content item has been removed from distribution, adding the content identifier to a list of content that should not be distributed, removing the content item from a list of content items that are allowed to be distributed, and any combinations thereof. In one example, a content item is removed from distribution by modifying metadata associated with the content item to include an indication that the content item has been removed from distribution. In this example, the content item is not deleted. However, in this example, a user that is presented with an interface (e.g., as discussed in stage 110) will not be presented with an opportunity to access this particular content item (e.g., the metadata is utilized to suppress display of the content item in one or more playlists of the interface).

Manual review may result in a determination that the content item should not be removed from distribution. In one such example, the flag for manual review associated with the content item is removed. In another example, a new flag may be associated with the content item to indicate that the content item should no longer be considered for removal regardless of future objections by users. In yet another example, a flag may be associated with the content item to indicate that the content item should be restricted to not allow access by one or more of the users that provided an indication of objection to that content item. In a further example, a flag may be associated with the content item to indicate that the content item should be restricted to a certain class of users (e.g., adult users). Although one or more restrictions of access may be placed on users that provided an indication of objection, the content item may be configured to be freely accessed by other users. Modifying the flag for manual review and/or adding one or more additional flags to a content item may be achieved in a variety of ways. Ways of flagging a content item include, but are not limited to, modifying metadata associated with the content item, adding the content item identifier to a list of approved content, adding the content item identifier to a list of restricted content, removing the content item from a list of content items that are allowed to be distributed, and any combinations thereof.

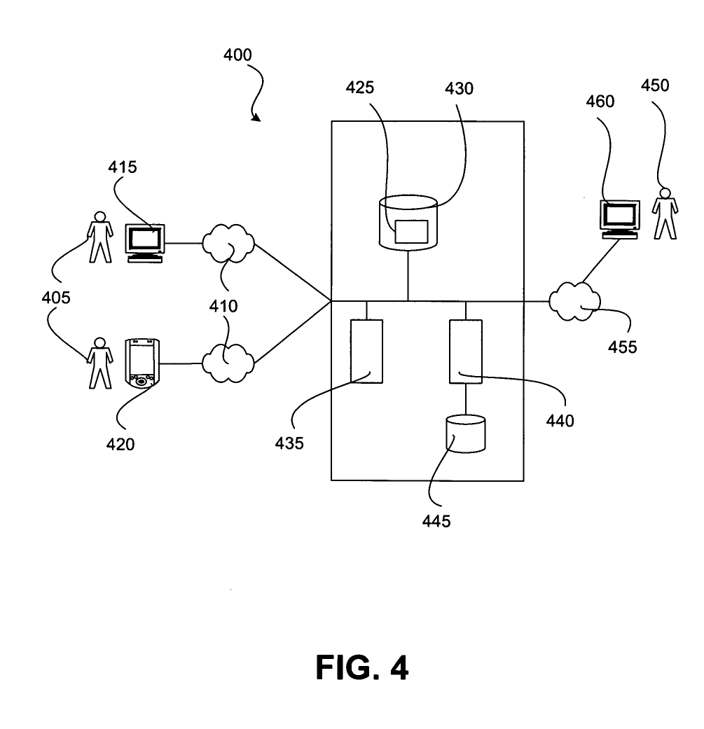

FIG. 4 illustrates one embodiment of a system 400 for removing a content item from distribution over a network. System 400 is configured to provide an interface for accessing one or more content items to one or more users 405 over one or more networks 410. It is also contemplated that any number of the one or more users 405 may be provided with a different interface (e.g., a dynamically generated interface) for accessing one or more content items than the interface(s) provided to one or more other users 405. Users 405 may access an interface provided by system 400 via a client device (e.g., a computing device). One of users 405 is shown accessing system 400 via a network 410 using a computing device 415 (e.g., a desktop computer). Another of users 405 is shown accessing system 400 via a network 410 using a computing device 420 exemplified as a mobile computing device (e.g., a mobile phone, a personal data assistant). Additional examples of computing devices that may be utilized to access a system (e.g., system 400) for removing a content item from distribution via a network are discussed below with respect to FIG. 7.

System 400 includes one or more content items 425. Content items 425 may be stored in one or more databases 430. System 400 also includes an interface generator 435. Interface generator 435 includes hardware and/or software for generating an interface for allowing access to a content item or items of one or more content items 425. The interface may include one or more displayable elements that include functionality for allowing a user that accesses a content item of the one or more content items 425 to provide an indication of one or more objections to the accessed content item. System 400 includes an objection reporting module 440. Objection reporting module 440 includes hardware and/or software for receiving and handling an indication of an objection to a content item. Data related to one or more indications of objection may be stored in an objection database 445. As discussed above with respect to method 100, indications of objection may be handled in a variety of ways. In one example, this data related to the indications of objections may include metadata associated with one or more content items 425. In another example, this data may include record data for each indication of objection reported by a user. Although objection database 445 is shown as separate from content item database 430, it is contemplated that any number of one or more databases may be utilized to store and handle data related to one or more content items 425, any related metadata, data related to access of each of content items 425, data related to indications of objections provided by one or more users 405, and any other data utilized by system 400. Objection reporting module 440 is also configured to monitor data in objection database 445 and data related to access of one or more content items 425 to determine if a first threshold percentage is met of users that have provided an indication of objection to a content item that they have accessed. If the first threshold is met, objection reporting module 440 flags the corresponding content item for manual removal.

Objection reporting module 440 is further configured to monitor data in objection database 445 to determine if a second threshold percentage is met of users providing an objection in conjunction with a threshold number of instances of access of the content item being met. If both the second threshold percentage and the threshold number of instances of access of the content item are met, objection reporting module 440 automatically removes the corresponding content item from distribution. Various ways of removing a content item are discussed above with respect to FIG. 1. An administrative user 450 may access system 400 via a network 455 and a computing device 460 (exemplified as a general computing device) to provide manual review of one or more content items 425 that have been flagged for manual review. Interface generator 435 is configured to provide administrative user 450 with an interface (e.g., an interactive displayable image that may be displayed via computing device 460) for accessing the one or more flagged content items 425. Although the same interface generator 435 is shown as being responsible for both the 405 user interface and the 450 administrative user interface, it is contemplated that a given implementation might utilize separate interface generators for each of a one or more user interfaces of system 400. Objection reporting module 440 or some other element of system 400 (e.g., a processor and/or controller) may be configured to facilitate removal of one or more content items after manual review determines that removal of the given content item is appropriate. Elements of system 400 may be included as part of, or associated with, one or more computing devices. For example, the functionality and associated hardware and/or software configuration of objection reporting module 440 and/or interface generator 435 may be implemented in any number of one or more elements and/or modules (e.g., software, controllers, processors, databases, etc.). A person of skill in the computing arts will recognize from the disclosure herein how to configure software and/or hardware components to implement any one or more of the aspects of system 400 discussed herein.

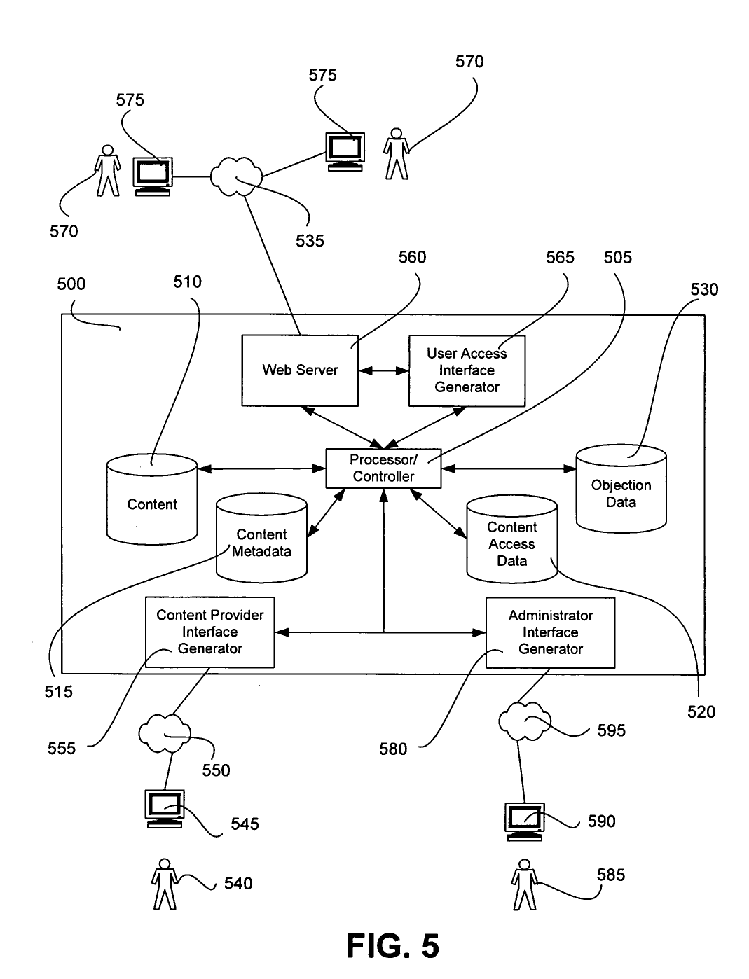

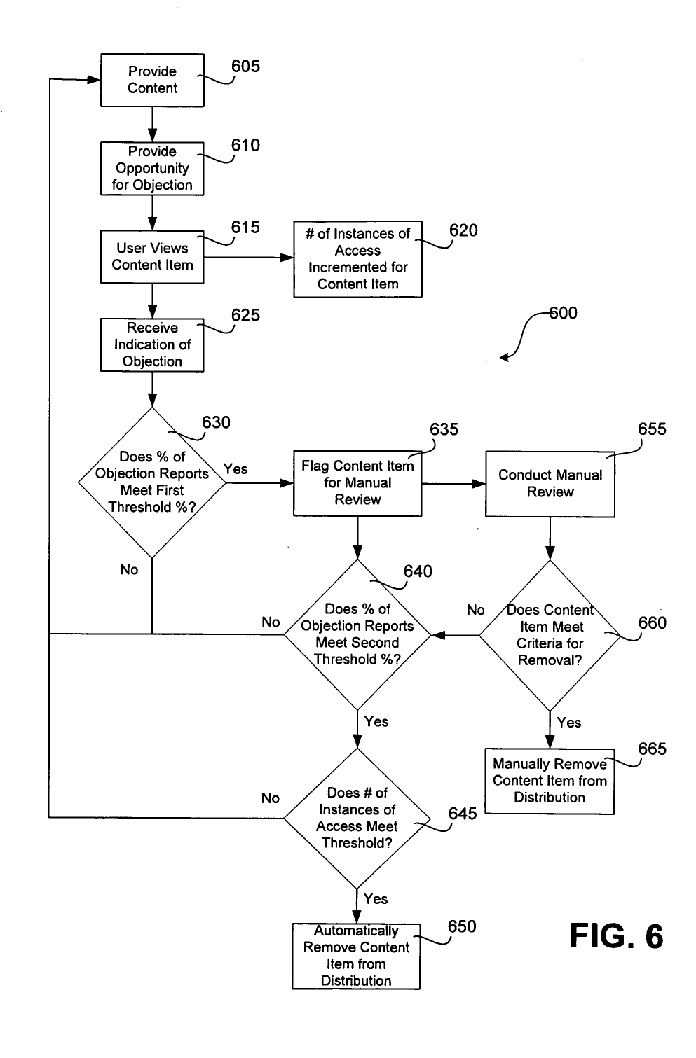

Additional exemplary aspects of a system for removing a content item from distribution over a network are discussed below with respect to another embodiment of a system 500 illustrated in FIG. 5. One or more of the aspects and examples discussed with respect to system 500 may be utilized with the implementation of one or more aspects of a method for removing a content item from distribution as described herein (e.g., method 100 of FIG. 1, method 600 of FIG. 6 described below).

System 500 includes a processor 505 for controlling one or more of the functionalities of system 500. Processor 505 may include hardware and/or software configured to command and direct operation of system 500. In one example, processor 505 includes and/or is embedded in a machine capable of executing instructions for implementing one or more aspects and/or embodiments of the present disclosure. One example of such a machine is discussed further below with respect to FIG. 7. It should be noted that it is contemplated that the various aspects of system 500 may be distributed across any number of one or more machines.

System 500 includes a content item database 510, a content metadata database 515, a content access database 520, and an objection database 530. Content item database 510 is configured to store one or more content items, which may be for distribution over a network 535. As discussed throughout this disclosure, a network, such as network 535, may be any type of network. In one example, network 535 may include one or more components of the Internet. Content metadata database 515 is configured to store data related to the one or more content items of content item database 510. Content access database 520 is configured to store data related to the accessing of content items of content item database 510. Objection database 530 is configured to store information related to one or more indications of objection to content items of content item database 510. A database may have any of a variety of forms known to those skilled in the computer arts. Example databases and various ways of storing data and metadata related to content items (e.g., access data, objection data) are discussed further above. Although, databases 510, 515, 520, and 530 are shown as separate entities, it is contemplated that any one or more of content item database 510, content metadata database 515, content access database 520, objection database 530, and any other database of system 500 may be implemented as any number of one or more data structures in any number of hardware and/or software configurations.

Content items may be provided to content item database 510 in a variety of ways. In one example, a content provider 540 may access system 500 via a computing device 545 and a network 550. Network 550 may include any one or more network components of various types. In one example, network 550 includes one or more components of the Internet. System 500 includes a content provider interface generator 555 for providing an interactive interface to content provider 540. In one exemplary aspect, content provider interface generator 555 is configured to provide an interface that allows content provider 540 to access system 500 and to transfer one or more content items to content item database 510. Content items may be stored by a content item database (e.g., content item database 510) in a variety of formats. Example video content item formats include, but are not limited to, MPEG (Moving Pictures Expert Group format), AVI (Audio Video Interleave format), WMV (Windows Media Video format), MP4, MOV (Quicktime video format), FLV (Flash video format) and any combinations thereof. Example image content item formats include, but are not limited to, JPEG (Joint Photographic Experts Group format), GIF (Graphics Interchange Format), TIFF(Tagged Image File Format), PNG (Portable Network Graphics format), and any combinations thereof. Example audio content item formats include, but are not limited to, MP3 (MPEG-1 Audio Layer 3 format), WMA (Windows Media Audio format), WAV (Waveform audio format), Real Media format, AAC (Advanced Audio Coding), and any combinations thereof. Example, text content item formats include, but are not limited to, ASCII text, Unicode text, EBCDIC text, and any combinations thereof. Content provider 540 may also provide metadata to associate with each of the one or more content items provided by content provider 540. In one example, such metadata may be stored in content metadata database 515. Example metadata includes, but is not limited to, a title of a content item, a description of a content item, a time window of availability of a content item, a category of a content item, a search keyword of a content item, a status indicator (e.g., available for distribution, flagged for manual review, removed from distribution, marked as permanently available for distribution), an identifier of a provider of a content item, a thumbnail representation of a content item, a flag controlling display of the content item on a Featured content item tab of an interface, a syndication distribution list that is associated with the content item, and any combinations thereof.

System 500 may also include a web server 560 and/or a user access interface generator 565. User access interface generator 565 is configured to provide an interactive interface via network 535 to one or more users 570 to provide one or more users 570 with access to one or more content items of system 500. In one exemplary aspect, user access interface generator 565 is also configured to provide an interface that allows one or more users 570 with an opportunity to provide system 500 with an indication of an objection to a content item accessed via the interface. Optional web server 560 is configured to facilitate communication between a client (e.g., an Internet browser) running on a computing device 575 of one or more users 570 that is provided the interface and system 500. In an alternate embodiment, one or more of the functions of each of web server 560 and user access interface generator 565 may be combined in a single module of software and/or hardware of system 500.

System 500 further includes an administrator interface generator 580. Administrator interface generator 580 is configured to provide an interactive interface to an administrative user 585 that utilizes a computing device 590 and a network 595 to access the interface. Network 595 may include any one or more network components of various types. In one example, network 595 includes one or more components of the Internet. In one exemplary aspect, Administrator interface generator 580 is configured to provide an interactive interface that allows administrative user 585 access to system 500 for manually reviewing one or more content items that are flagged for manual review.

Exemplary utilization of aspects of system 500 are discussed further below with respect to another exemplary implementation 600 of a method for removing a content item from a distribution network. Method 600 is illustrated in FIG. 6. Although, method 600 is discussed in relation to system 500, it is contemplated that method 600, its various aspects and examples, may be implemented utilizing any system capable of executing the functionality described with respect to method 600.

At stage 605, method 600 includes providing access to one or more content items via an interface to one or more users 570. At stage 610, the interface is provided with a functionality that allows a user 570 to provide an indication of objection to a content item accessed via the interface. At stage 615, the user accesses a content item via the interface (e.g., the user views a video content item of content item database 510 via the interface). At stage 620, an indicator of the total number of instances of access of the content item is incremented to represent the access of the content item by the user. In one example, content access data of content access database 520 that is associated with the accessed content item is modified to indicate that the content item has been accessed. In one such example, a data record may be created for each instance of accessing of a given content item. Example information that may be included in such a data record includes, but is not limited to, an indication of a content item accessed, an identifier of a user that accessed a content item, an indication of the amount of a content item actually accessed by a user (e.g., an amount of a video watched by a user), an indication of a time and/or date associated with the accessing of a content item, an identifier of an interface utilized by a user to access a content item, and any combinations thereof. Other examples of tracking the total number of instances of access of a content item are discussed above.

At stage 625, an indication of objection is received from one of users 570 that has accessed the content item via the interface and felt a need to provide such an indication. Information related to the indication of objection is stored in objection database 525. In one example, processor 505 facilitates the collection and storage of the indication in objection database 530. As discussed above, data related to one or more indications of objection may be stored in a variety of ways. In one example, objection data of objection database 525 may be organized as a separate record for each indication of objection received. Such an objection data record may include a variety of information. In one example, an objection data record includes an identification of a content item objected to by a user 570 and any metadata provided as part of the objection. An objection data record may also include, but is not limited to, an identifier of a user 570 making the objection, an identifier of a particular access interface utilized by user 570 to access system 500, one or more categories associated with an objection, an identifier of a content item from content database 510, an indicator of a date and/or time of an objection, an indicator of other information related to an objection to a content item, and any combinations thereof.

At stage 630, a determination is made whether a percentage of users that have submitted an objection to the content item that they have accessed meets a first threshold percentage. In one example, processor 505 may periodically access content metadata database 515, content access database 520, and objection database 525 to correlate information stored therein for each content item to determine a total number of instances of access for each content item and a number of objections made by users accessing each content item. In another example, processor 505 may access content metadata database 515, content access database 520, and objection database 525 for a specific content item to correlate information stored therein to determine a total number of instances of access for that content item and a number of objections made by users accessing that content item. From such information, a percentage of users that have submitted an objection may be determined. This percentage is compared against a first threshold percentage to determine if the first threshold percentage is met. It is contemplated that a threshold percentage and/or a threshold number of instances of access may be stored in a variety of ways in a system, such as system 500. In one example, one or more threshold values may be stored in a database and/or other computer storage device (e.g., database 510, 515, 520, 530). Exemplary computer storage devices are discussed further below with respect to FIG. 7.

In an alternative embodiment, information related to number of instances of access and objection information may only be reviewed for a certain period of time. In one example, metadata in objection database 525 and content access database 520 may be accessed to determine a time and/or date stamp associated with each accessing of a content item record and objection record. In this example, only those records that occur within a certain predetermined period of time (e.g., one or more days, one or more months, one or more weeks, etc.) are utilized to determine percentages of user objections and/or total instances of access.

If the first threshold percentage is met, the content item is flagged for manual review at stage 635. In one example, if the content item is already flagged, no additional flagging is necessary. Flagging may occur in a variety of ways. In one example, metadata for the content item in content metadata database 515 includes a status indicator for the content item. In one such example, the status indicator may have a variety of values. Exemplary values for a status indicator include, but are not limited to, an indicator that the content item is currently available to be accessed, an indicator that the content item is flagged for manual review, an indicator that the content item has been removed from distribution, an indicator that a content item should never be removed from distribution, and any combinations thereof. In one example, a status indicator in database 515 has possible values that include a value of “0” for available for access, a value of “1” for flagged for manual review, a value of “2” for removed from distribution, and a value of “−1” to indicate that the content item should not be removed manually or automatically from distribution. In one example, processor 505 may recognize a status indication that a content item should never be manually or automatically removed and not change the status indicator regardless of the percentage of objections received from one or more users 570. Method 600 may proceed to stage 640. If the first threshold percentage is not met at stage 630, method 600 continues allowing access to content items by one or more users 570 at stage 605.

At stage 640, a determination is made whether the percentage of users that have submitted an objection to the content item meets a second threshold percentage. In one example, processor 505 may access (e.g., periodically, when triggered, or otherwise) content metadata database 515, content access database 520, and objection database 530 to correlate information stored therein for each content item to determine a total number of instances of access for a content item and a number of objections made by users accessing a content item.

In this example implementation of method 600, the second threshold percentage is greater than the first threshold percentage. However, in alternate examples, the second threshold percentage may be less than and/or equal to the first threshold percentage, and method 600 is readily adaptable to such examples. If the percentage of users that have submitted an objection to the content item does not meet the second threshold percentage at stage 640, method 600 continues allowing access to content items by users at stage 605. If the percentage of users that have submitted an objection to the content item does meet the second threshold percentage at stage 640, method 600 continues to stage 645.

At stage 645, a determination is made whether a number of instances of access of the content item meets a predetermined threshold number of users. In one example, processor 505 may access (e.g., periodically, when triggered, or otherwise) content access database 520 to determine a total number of instances of access for a content item. If the number of instances of access of the content item does not meet the predetermined threshold number of users, method 600 continues for access to content items by users at stage 605. If the number of users that have accessed the content item meets the predetermined threshold number of users, the content item is automatically removed from distribution at stage 650. In one example, processor 505 facilitates the modification of metadata associated with the content item to indicate that the content item should be removed from distribution. It should be noted that stages 640 and 645 may be executed in another example with stages 640 and 645 occurring in a different order than shown in method 600 (e.g., with stage 645 occurring before or substantially simultaneously with stage 640). In another example, it is possible to execute stages 640 and 645 before or substantially simultaneously with stage 630 (e.g., if the second threshold is lower than the first threshold).

Manual review of a content item that is flagged for manual review may occur at stage 655. In one example, such review may occur by an administrative user 585 via an interface provided by administrator interface generator 580, network 595, and computing device 590. At stage 660 a determination is made whether the manually reviewed content item meets one or more criteria for removal from distribution. Various ways of determining whether a content item should be removed from distribution exist. Examples are discussed above (e.g., with respect to FIG. 1). If the content item meets one or more criteria for removal from distribution, the content item is removed from distribution at stage 665. In one example, processor 505 may facilitate modification of metadata associated with the content item to indicate that the content item is removed from distribution. If the content item does not meet a criteria for removal from distribution, in one example, the content item may be processed according to stage 640 and/or stage 645 for automatic removal. In another example, if the content item does not meet a criteria for removal from distribution, method 600 continues allowing access to content items by users at stage 605.

In an alternative embodiment, the concepts described above can be used to screen one or more bodies of content for delivery to diverse geographic areas, while learning and/or obeying local standards. In one implementation, an exemplary body of content is made available to multiple users in multiple geographic regions via the preceding system. Over a period of time, the responses of these users are correlated with their geographic regions to form a sample of user content attitudes by region. This sample can then be used to predict whether a new content item that is similar to one of the exemplar content items is likely to be found offensive in a given geographic region. This information can be used to selectively screen out potentially offensive content items for delivery into regions where they would likely violate local standards. In one alternative implementation, geographically based information related to one or more content items is updated with additional information provided by user objections in one or more geographic regions. In another alternative implementation, information regarding the standards of objectionability for a given region may be updated with additional information related to indications of objection from one or more additional content items. In yet another alternative implementation, the objectionable nature of a particular content item may be updated based on additional information of indications of objection provided by users accessing the content item. For example, a content item that may be considered as “borderline” objectionable for a given geographic region (e.g., based on historic information learned from indications of objection of other content items, may be made available for distribution over a network to that geographic region. The response by one or more users (e.g., indications of objection) and/or lack of response may be utilized to update the objectionable nature of the particular content item (e.g., removing the content item from distribution for that geographic region). The response and lack of response information may also be utilized to update the user content attitude standards for that geographic region. In one such example, a “borderline” objectionable content item may intentionally be utilized as a tool for building a more representative standard of objectionability in a given geographic region.

The geographic screening system described above can be readily modified by one of normal skill in the art to screen communities of users that are grouped in manners other than geography. For example, the system would work similarly if user age group were substituted for geographic region.

In yet another embodiment, the aspects and embodiments discussed herein may be implemented with more than two threshold levels. For example, stages 130 and 140 of method 100 may be supplemented with any number of additional screening levels (e.g., including a percentage threshold level and/or a total access instance threshold number). In one example, in such an additional screening level the additional percentage threshold and/or the total access instance threshold number may be set to zero. In one exemplary implementation, content items flagged under each level can be sent to a different set of reviewers. This would allow content items flagged under the first level to be sent to, in one example, a large group of volunteer screeners, while content flagged under the higher levels could be sent to progressively smaller groups of progressively better trained (and, for example, more expensive) screeners. The top level could still result in automatic removal of the content item. For example, a method of removing a content item from distribution via a network interface may include a first level of screening (e.g., stage 130) where if a percentage of objections to a content item meets a first threshold percentage, the content item is marked for manual review by a first class of reviewers; a second level of screening where if a percentage of objections to a content item meets a first additional threshold percentage, the content item is marked for manual review by a second class of reviewers; . . . an n−1 level of screening where if a percentage of objections to a content item meets another additional threshold percentage, the content item is marked for manual review by yet another class of reviewers; and an n level of screening where if a percentage of objections to a content item meets a second threshold percentage and a number of access instances meets a threshold number, the content item is automatically removed from distribution. As the levels increase the level of training, availability, responsibility, etc. of the manual reviewers may increase. For example, the first class of manual reviewers may only work days whereas the highest level of manual reviewers may be on-call for manual review around the clock.

In still another embodiment, the aspects and embodiment disclosed herein may be implemented such that a non-final level of screening of a content item (e.g., stage 130 of method 100, stage 630 of method 600) also includes determining if a total number of instances of access of the content item meets a certain threshold number. In one example, this threshold number may be set low at early stages of screening, but high enough to filter out one or more situations where a few or even a single objection may trigger flagging a content item for manual review. For example, if a first threshold percentage were set at 15% and the first user to access a content item provided an indication of objection, the percentage of objections would be 100% and would trigger a manual review. In one exemplary aspect, a first percentage threshold may be coupled with an access instance threshold number. In one such example, if the first threshold percentage is 15% and the access instance threshold number is set to 10, when a first user provides an indication of objection and none of the next nine users object, the percentage of objection first considered would be 10%. This would not meet the threshold.

In one exemplary aspect, one or more examples of a system and/or method for removing a content item from distribution configured according to the present disclosure may provide an efficient and/or speedy way to remove a content item from distribution over an interface where the content item actually meets one or more criteria for removal of the operator of the interface. In another exemplary aspect, example higher level screening stages requiring both a second threshold percentage and a threshold number of access instances to be met may decrease the likelihood that content items falsely indicated by one or more users as objectionable will be automatically removed from distribution. In yet another exemplary aspect, example higher level screening stages requiring both a second threshold percentage and a threshold number of access instances may allow a content item that is truly objectionable (e.g., meets one or more criteria of an operator of an interface, meets a general standard of inappropriateness) to be appropriately automatically removed from distribution despite a potential unavailability and/or other disruption in manual review.

It is to be noted that the aspects and embodiments described herein may be conveniently implemented using one or more machines (e.g., a computing device) programmed according to the teachings of the present desclosure, as will be apparent to those of ordinary skill in the computer art. For example, various aspects of a method for removing a content item from distribution over a network as described herein, may be implemented as machine-executable instructions (i.e., software coding), such as program modules executed by one or more machines. Typically a program module may include routines, programs, objects, components, data structures, etc. that perform specific tasks. Appropriate machine-executable instructions can readily be prepared by skilled programmers based on the teachings of the present disclosure, as will be apparent to those of ordinary skill in the software art.

Such software may be a computer program product that employs a machine-readable medium. Example computer programs include, but are not limited to, an operating system, a browser application, a micro-browser application, a proxy application, a business application, a server application, an email application, an online service application, an interactive television client application, an ISP client application, a gateway application, a tunneling application, a client-side Flash application, and any combinations thereof. A machine-readable medium may be any medium that is capable of storing and/or encoding a sequence of instructions for execution by a machine (e.g., a computing device) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, a punched paper tape, a smart card, and any combinations thereof. A machine-readable medium, as used herein, is intended to include a single medium as well as a collection of physically separate media, such as, for example, a collection of compact disks or one or more hard disk drives in combination with a computer memory.

Examples of a computing device include, but are not limited to, a computer; a special purpose computer; a computer workstation; a terminal computer; a notebook/laptop computer; a server computer; a handheld device (e.g., tablet computer, a personal digital assistant “PDA”, a mobile telephone, etc.); a web appliance; a network router; a network switch; a network bridge; a set-top box “STB;” video tape recorder “VTR;” a digital video recorder “DVR;” a digital video disc “DVD” device (e.g., a DVD recorder, a DVD reader); any machine, component, tool, equipment capable of executing a sequence of instructions that specify an action to be taken by that machine, a Turing machine and any combinations thereof. In one example, a computing device may include and/or be included in, a kiosk. In another example, a computing device includes a mobile device. In yet another example, a computing device includes a device configured for display of video and/or audio content accessed over a network.

FIG. 7 shows a diagrammatic representation of one embodiment of a general purpose computing device in the exemplary form of a computer system 700 within which a set of instructions for causing the computing device to perform any one or more of the aspects and/or methodologies of the present disclosure may be executed. It should be noted that although computer system 700 itself and its components may be shown as singular entities, each component and computer system 700 may include any number of components configured to perform a certain functionality. For example, multiple computer systems 700 may combine to perform any one or more of the aspects and/or methodologies of the present disclosure. Additionally any one aspect and/or methodology of the present disclosure may be dispersed across any number of computer system 700 or across any number of computer system components.

Computer system 700 includes a processor 705 and a memory 710 that communicate with each other, and with other components, via a bus 715. Bus 715 may include any of several types of bus structures including, but not limited to, a memory bus, a memory controller, a peripheral bus, a local bus, a NUMA bus, a distributed system networking bus (e.g., a simulated network that links multiple instances of virtual machines), and any combinations thereof, using any of a variety of bus architectures.

Memory 710 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 720 (BIOS), including basic routines that help to transfer information between elements within computer system 700, such as during start-up, may be stored in memory 710. Memory 710 may also include (e.g., stored on one or more machine-readable media) instructions (e.g., software) 725 embodying any one or more of the aspects and/or methodologies of the present disclosure. In another example, memory 710 may further include any number of program modules including, but not limited to, an operating system, one or more application programs, other program modules, program data, one or more virtual machines and any combinations thereof.

Computer system 700 may also include a storage device 730. Examples of a storage device (e.g., storage device 730) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, a storage array network, and any combinations thereof. Storage device 730 may be connected to bus 715 by an appropriate interface (not shown). Example interfaces include, but are not limited to, SCSI, advanced technology attachment (ATA), serial ATA, universal serial bus (USB), IEEE 1394 (FIREWIRE), iSCSI, Fiber Channel, and any combinations thereof. In one example, storage device 730 may be removably interfaced with computer system 700 (e.g., via an external port connector (not shown)). Particularly, storage device 730 and an associated machine-readable medium 735 may provide nonvolatile and/or volatile storage of machine-readable instructions, data structures, program modules, and/or other data for computer system 700. In one example, software 725 may reside, completely or partially, within machine-readable medium 735. In another example, software 725 may reside, completely or partially, within processor 705.

Computer system 700 may also include an input device 740. In one example, a user of computer system 700 may enter commands and/or other information into computer system 700 via input device 740. For example, a user may utilize a computing device with an input device, such as input device 740 to enter metadata related to a content item, select a link to provide an indication of objection to a content item, etc. Examples of an input device 740 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, a multitouch interface, and any combinations thereof. Input device 740 may be interfaced to bus 715 via any of a variety of interfaces (not shown) including, but not limited to, a serial interface, a parallel interface, a game port, a USB interface, a FIREWIRE interface, a direct interface to bus 715, and any combinations thereof.

A user may also input commands and/or other information to computer system 700 via storage device 730 (e.g., a removable disk drive, a flash drive, etc.) and/or a network interface device 745. A network interface device, such as network interface device 745 may be utilized for connecting computer system 700 to one or more of a variety of networks, such as network 750, and one or more remote computing devices 755 connected thereto. Examples of a network interface device include, but are not limited to, a network interface card, a modem, a wireless networking card, and any combinations thereof. A network may include one or more elements configured to communicate data (e.g., direct data, deliver data). Examples of a network element include, but are not limited to, a router, a server, a switch, a proxy server, an adapter, an intermediate node, a wired data pathway, a wireless data pathway, a firewall, and any combinations thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 750, may employ a wired and/or a wireless mode of communication. Various communication protocols (e.g., HTTP, WAP, TCP/IP, UDP/IP) and/or encryption protocols (e.g., SSL) may be utilized in connecting and/or for communication over a network, such as network 750. In general, any network topology may be used. Information (e.g., data, software 725, etc.) may be communicated to and/or from computer system 700 via network interface device 745. In yet another example, storage device 730 may be connected to bus 715 via network interface 745. In still another example, input device 740 may be connected to bus 715 via network interface 745.

Computer system 700 may further include a video display adapter 760 for communicating a displayable image to a display device, such as display device 765. For example, video display adapter 760 may be utilized to display an interface for accessing one or more content items over a network to display device 765. Examples of a display device include, but are not limited to, a liquid crystal display (LCD), a cathode ray tube (CRT), a plasma display, a teletype machine, and any combinations thereof. In addition to a display device, a computer system 700 may include one or more other peripheral output devices including, but not limited to, an audio speaker, a printer, and any combinations thereof. Such peripheral output devices may be connected to bus 715 via a peripheral interface 770. Examples of a peripheral interface include, but are not limited to, a serial port, a USB connection, a FIREWIRE connection, a parallel connection, and any combinations thereof.

A digitizer (not shown) and an accompanying pen/stylus, if needed, may be included in order to digitally capture freehand input. A pen digitizer may be separately configured or coextensive with a display area of display device 765. Accordingly, a digitizer may be integrated with display device 765, or may exist as a separate device overlaying or otherwise appended to display device 765.

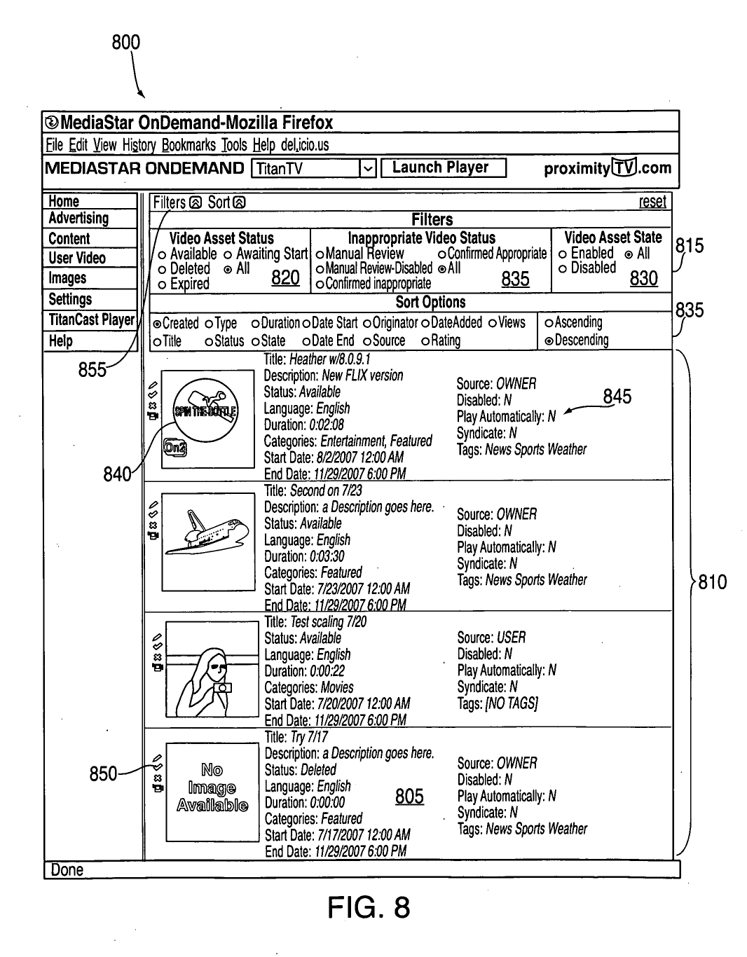

As discussed above with respect to the various aspects and embodiments disclosed herein, a manual review may be implemented (e.g., after a content item is flagged for manual review upon a percentage of users objecting to the content item, after a content item is automatically removed from distribution upon a threshold number of users objecting to the content item). FIGS. 8 to 14 illustrate exemplary interfaces for a user (e.g., an administrative user). The exemplary interfaces are shown as Internet website based interfaces.

FIG. 8 shows one example of an administrative interface 800 including an exemplary manual review queue 805 that may be utilized with one or more manual reviews as discussed above. Exemplary manual review queue 805 lists representations of content items 810 (e.g., content items flagged for manual review, content items automatically removed from distribution, combinations thereof). Exemplary controls 815 (“Video Asset Status” filter 820, “Inappropriate Video Status” filter 825, and “Video Asset State” filter 830) at the top of the screen allow a user (e.g., an administrative user) to filter the queue to show a subset of the available entries. The filters can be employed singly or in combination. In this exemplary discussion, content items are discussed as video items for exemplary purposes. Other types of content items may be substituted and/or added to a manual review interface as in this example. In this exemplary discussion, a user is typically an administrative user (e.g., a distributor of one or more content items, an operator of a content distribution system). It is also contemplated that other types of users may utilize an administrative interface, such as interface 800.

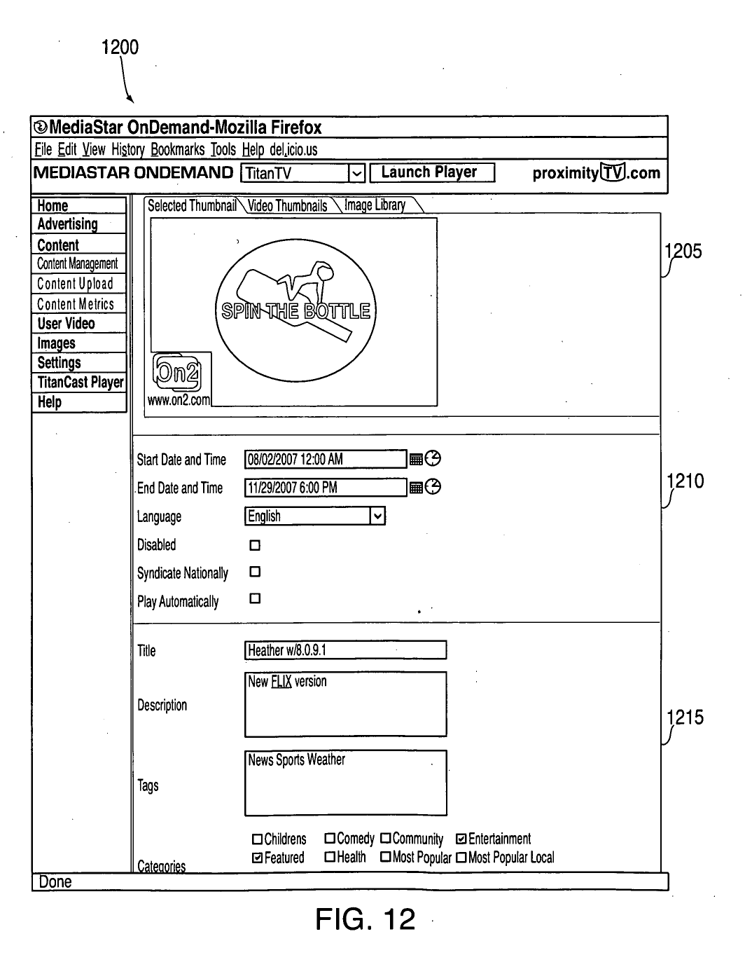

“Video Asset Status” filter 820 allows the user to show videos from a single status category (Available=available to the player, Awaiting Start=a video that has not reached its start date, Deleted=a deleted video, Expired=a video that is past its end date). Content status categories are discussed further below with respect to FIG. 12.

“Inappropriate Video Status” filter 825 allows an administrative user to filter the queue to display videos from various stages of an inappropriate screening workflow. Selection of “Manual Review” in filter 825 shows videos that have been flagged for manual review (e.g., via a process as described above with respect to method 100, method 600). Selection of “Manual Review—Disabled” in filter 825 shows videos that were flagged for manual review and subsequently flagged for automatic removal (i.e., they were automatically disabled removed from distribution). Selection of “Confirmed Inappropriate” in filter 825 shows videos where an administrative user has confirmed the inappropriate flag. Selection of “Confirmed Appropriate” in filter 825 shows videos for which an administrative user has overridden the inappropriate flag (i.e., confirmed the video as appropriate) after manual review or automatic removal. Selection of “All” in filter 825 shows videos with any objection related status.

“Video Asset State” filter 830 allows an administrative user to filter queue 805 to show “Enabled” content (e.g., videos available for distribution), “Disabled” content (e.g., videos removed from distribution, either manually after review or automatically) videos, or “All” content (e.g., enabled and disabled content).

FIG. 8 also shows sort controls 935 that allow an administrative user to control the display order of videos in queue 805. The user can sort by the Created date, Title, Type of video, Status, Duration, State, Date Start, Date End, Originator, Source, Date Added, Rating, and number of Views (e.g., number of instances of access over a network). Sorts can be ascending or descending order.

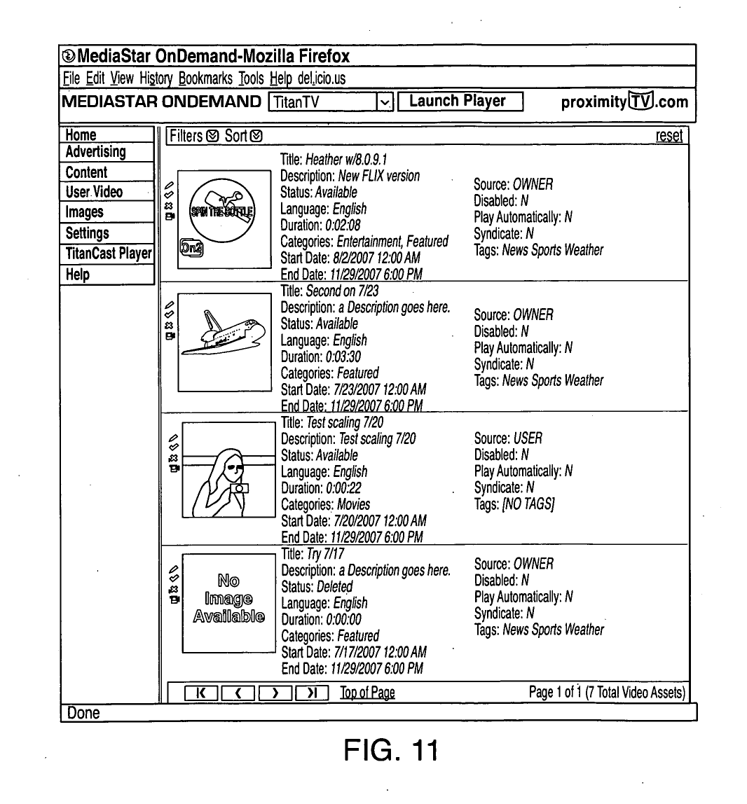

Queue 805 display may be divided into several display pages. Controls at the bottom of the first page (not shown in FIG. 8) may allow a user to switch among various display pages (see FIG. 11 for an example of such controls at the bottom of a page). Each listing of a content item 810 includes a corresponding thumbnail 840 and a synopsis 845 of one or more of the available metadata for the video. For example, the content item titled “Heather w/8.0.9.1” includes a square thumbnail to the left of the title and other synopsis information (e.g., description, status, language, duration, categories, start date, end date). Controls 850 to the left of each thumbnail 840 allow a user to manipulate the video status and metadata. Controls 850 include a pencil icon, a check mark icon, a movie projector icon, and an “X” icon for each content item 810 in queue 805. Selection of the pencil icon allows an administrative user to edit (e.g., via a video edit interface) the video metadata, including selection of a different thumbnail. FIG. 12 shows a portion of an exemplary video edit interface. Selection of the movie projector icon allows the user to view the corresponding content item/video in a separate window.

Selection of the check mark icon allows the user to override a flag of objected to status (e.g., a flag for manual review, a flag indicating that the item was automatically removed from distribution), giving it a status of “Confirmed Appropriate”. In one exemplary implementation, videos with this status (e.g., with metadata flagged for this status) will be removed from the inappropriate flagging workflow. Users of a content display interface for displaying the content item via a network will not be able to further provide an indication of objection (e.g., flag these videos as inappropriate). In an alternate implementation, video player users would be able to manipulate the content display user interface to provide an indication of objection (e.g., flag these videos as inappropriate), but their actions would be discarded or otherwise disregarded. Such an implementation may give video display interface users a sense of control without forcing an administrative user to repeatedly review a video that had previously been determined to be appropriate for the particular display interface. In yet another implementation, videos with this status could be subjected to a different set of cutoffs for manual (e.g., percentage) or automatic (e.g., percentage and number threshold) removal. For example, this status could effectively double the percentage and/or view count thresholds. Other treatments of the “Confirmed Appropriate” status are contemplated as possible.

Selection of the “X” icon allows an administrative user to confirm the inappropriate status, giving the video a status of “Confirmed Inappropriate”. Videos with this status will not be shown in the player.

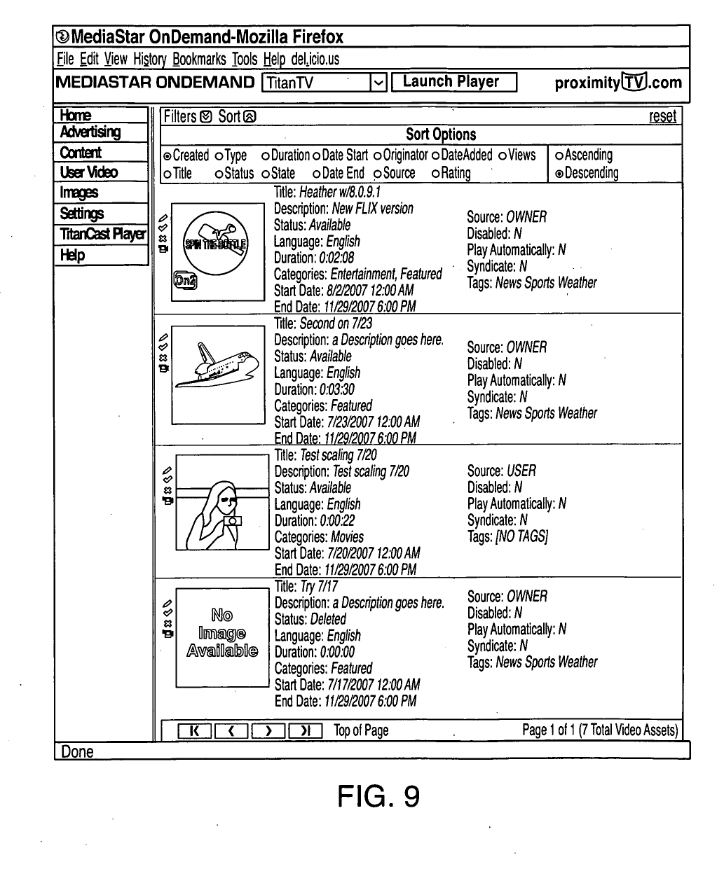

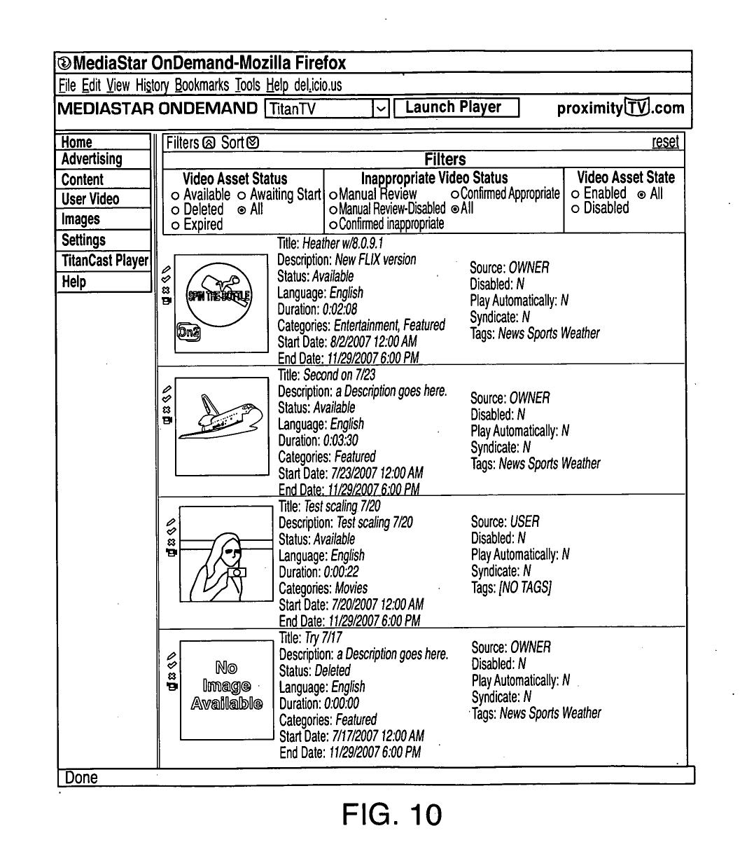

The Sort 835 and Filters 815 sections can be hidden by an administrative user. FIG. 9 shows an exemplary queue with its Filters section hidden. FIG. 10 shows an exemplary queue with its Sort section hidden. FIG. 11 shows an exemplary queue with both its Filters section and Sort section hidden.

FIG. 12 shows a screen shot of one exemplary content edit interface 1200. Content edit interface 1200 allows an administrative user to edit metadata associated with a one or more content items (e.g., a video). A top section 1205 allows a user to view and change the thumbnail that is associated with the video. A middle section 1210 allows a user to set a Start and End date and time that the video should be available for distribution over a network (e.g., via a content display interface). Videos with a Start Date and Time that is in the future may have an asset status of “Awaiting Start.” Videos with an End Date and Time that is in the past may have an asset status of “Expired.” Section 1210 also has controls to set the Enabled/Disabled state of the video, a check box to allow video syndication and a check box to allow the user to designate the video to play automatically when a user opens a content display interface for accessing the content item over a network. A bottom section 1215 (shown partially in FIG. 12) allows a user to edit content item metadata (e.g., title, description, keywords/tags, categories, etc.). One reason that a display interface user might flag a video as inappropriate is that the metadata (e.g., the title) is determined to be offensive to the user. Interface 1200 allows an administrative user to review, and possibly modify, metadata indicated as objectionable. It could also be used to temporarily disable a video pending review by another administrative user (e.g., by toggling the “Disabled” control of section 1210).

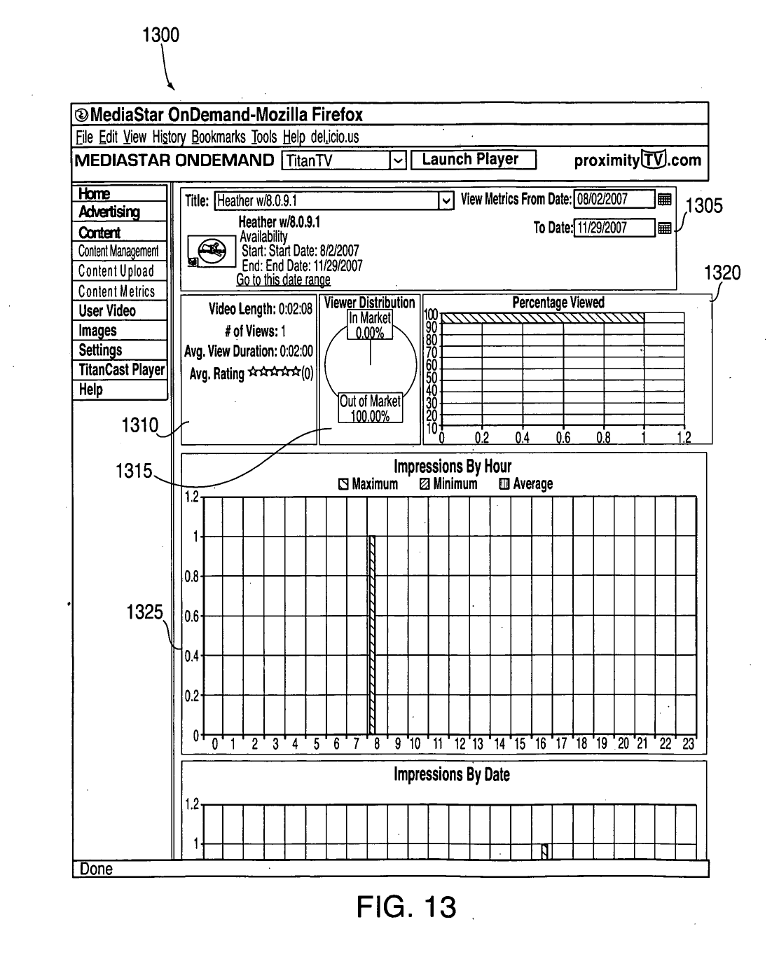

FIG. 13 shows a screen shot of one exemplary metrics interface 1300 for displaying data related to content item access and data related to indications of objection. Display section 1305 includes information about the content item being reviewed (e.g., title, metadata such as start and end date). Section 1305 also includes selection controls for allowing an administrative user to select the start (“from date”) and end (“to date”) for the range of time for which the information displayed by interface 1300 will be related. Display section 1310 includes information about the length of the content item, the number of instances of access (“# of Views”), average duration of an instance of access (“Avg. View Duration”), and average rating (“Avg. Rating”) for the content item shown and time period selected in section 1305. A display section 1315 illustrates data related to percentage of instances of accessing the content item by users having a geographic region (e.g., DMA) that match that of the entity providing the display interface for the content item versus those that are outside the geographic region (e.g., DMA) of the entity providing the interface. A display section 1320 illustrates data related to the percentage of the content item accessed by users. A display section 1325 illustrates data related to the maximum, minimum, and average number of instances of accessing the content item at various times of the day. Additional information that may be displayed in metrics interface, such as interface 1300, includes data related to number of instances of access of the content item by date (as partially shown in the screen shot of FIG. 13), data related to percentage of users accessing the content item on an originating distribution site that may have syndicated copies of the content item, and any combinations thereof. In one example, data to populate a metrics interface may be derived from a variety of sources related to the display interface for distributing the content item over a network. In one such example, the data may be collected from display users and stored in a database (e.g., content metadata database 515, content access database 520, content database 510, objection data database 530 of system 500 of FIG. 5). An administrative user may utilize a metrics interface to assist in decision making. For example, a video that had a long viewing history before being flagged might be deemed to be “safer” than a video that was flagged soon after release, or one that was unviewed until recently.

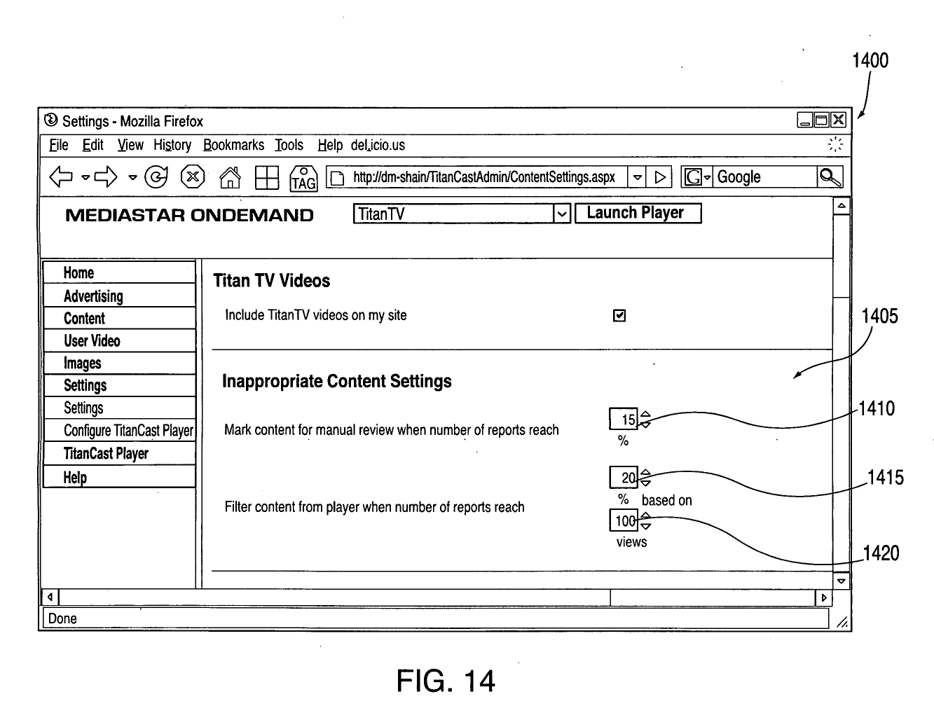

FIG. 14 shows a partial screen shot of an exemplary interface 1400 for configuring setting of a content item and/or a content item distribution system (e.g., system 500). Interface 1400 includes a display section 1405 that includes a manual review percentage threshold input element 1410. Percentage threshold input element 1410 may be utilized by an administrative user to set the threshold percentage of users providing an indication of objection that will be used to flag one or more content items for manual review. Display section 1405 also includes an automatic removal percentage threshold input element 1415 and an automatic removal number of instances of access threshold input element 1420. Percentage threshold input element 1415 may be utilized by an administrative user to set the threshold percentage of users providing an indication of objection that will be used (in part with a number of instances of access threshold) in determining if a content item should be automatically removed from distribution. Threshold number input element 1420 may be utilized by an administrative user to set the threshold number of instances of access that will be used (in part with the automatic percentage threshold value) in determining if a content item should be automatically removed from distribution. In one example, values set via input elements 1410, 1415, 1420 is utilized in relation to a particular one or more content items for distribution over a network. In another example, values set via input elements 1410, 1415, 1420 is utilized in relation to all content items available via one or more interfaced for distribution over a network. In one exemplary aspect, an administrative user can set content item distribution to be relatively tolerant of potentially offensive content, while another administrative user can set content item distribution to be relatively strict about content standards. Such flexibility may allow the same content item distribution infrastructure (e.g., system 500 of FIG. 5) to serve a plurality of divergent content item distribution interfaces (e.g., a swimsuit video player and a children's video player).

Aspects and embodiments of a system and method for removing a content item from distribution are discussed above in part with respect to receiving an indication of objection via an interface (e.g., a user interface, a display interface, an objection interface, etc.). It is contemplated that removal of a content item from distribution may be based on information received in other ways. Such ways include, but are not limited to, an email from a user, a periodic summary of one or more user objections compiled by an application that exposes the content item to one or more users outside of a content item access interface, one or more real time objections collected by an application that exposes the content item to one or more users outside of a content item access interface, and any combinations thereof. In one example, removal of a content item from distribution may be based on information received only from a source that is not an interface used to access the content item. In another example, removal of a content item from distribution may be based on information received from an interface associated with an interface utilized to access the content item and information received from another source. In one such example, a percentage of instances of objection and a number of instances of access may be based on data of indications of objection and of instances of access received from content accessing users via an interface and data of indication of objection and instances of access received from a content item owner via a data transfer mechanism (e.g., an email, a data file, a web services call, an RSS feed, etc.). In one implementation, data related to indications of objection and instances of access (regardless of source) can be utilized to flag a content item for manual removal when a first threshold percentage of users that have accessed the content item provide an indication of objection and automatically removed when a second threshold percentage of users that access the content item provide an indication of objection and a threshold number of instances of access is met. Such a removal procedure for a content item may be utilized, for example, in a programmatic application that is independent of an interface.

Terms such as first, second, and third may be utilized herein to provide ease of distinction between elements and are not intended to necessarily designate any particular order or magnitude of relationship between the elements. Additionally, for the sake of brevity, certain aspects and embodiments are described herein as including a single element (e.g., a single computing element) or as including a plurality of elements (e.g., multiple databases for storing data elements). It is contemplated that single elements may include multiple elements and multiple elements as shown may be configured as any number of one or more elements.

It is also contemplated that any one or more of the aspects and embodiments discussed above may be implemented in a distributed fashion (e.g., such that one or more steps of a method are performed by one entity and one or more other steps of the method are performed by a second entity). For example, one entity may be responsible for storing content item files, one entity may be responsible for storing content item metadata, one entity may be responsible for providing an interface for accessing a content item, one entity may be responsible for maintaining information regarding indications of objection and instances of access, and another entity may be responsible for determining if a content item should be flagged for manual review and/or automatically removed from distribution.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A computer-implemented method for removing a potentially objectionable content item from distribution over a network, the method comprising:
providing an interface over the network allowing access to a first content item to a plurality of users;
allowing one or more of the plurality of users to provide an indication of objection to the first content item via the interface;
receiving one or more indications of objection from one or more of the plurality of users that access the first content item;
determining an objecting percentage of the users that access the first content item that provide an indication of objection;
flagging the first content item for manual review when the objecting percentage meets a first threshold percentage; and
automatically removing the first content item from distribution via the interface when the objecting percentage meets a second threshold percentage and the total number of instances of access of the first content item meets a third threshold number.

2. A method according to claim 1, wherein the content item includes video content.

3. A method according to claim 1, wherein the second threshold percentage is greater than the first threshold percentage.

4. A method according to claim 1, wherein said allowing one or more of the plurality of users to provide an indication of objection includes providing one or more interface elements that allows a user to provide a free-form comment related to the objection.

5. A method according to claim 1, wherein said allowing one or more of the plurality of users to provide an indication of objection includes providing one or more interface elements that allows a user to provide an indication of a one or more categories for the objection.

6. A method according to claim 1, further comprising categorizing any objections received.

7. A method according to claim 6, further comprising:
manually reviewing the first content item to determine if the first content item meets one or more criteria for manual removal from distribution, wherein said manually reviewing includes consideration of one or more resulting categories of any objections received.

8. A method according to claim 1, wherein the objecting percentage is determined by a process that includes assigning one or more weighting factors to at least one indication of objection.

9. A method according to claim 1, wherein said flagging the first content item includes modifying metadata associated with the first content item to indicate that the first content item should be manually reviewed.

10. A method according to claim 1, further comprising:
manually reviewing the first content item to determine if the first content item meets one or more criteria for manual removal from distribution; and
manually removing the first content item from distribution.

11. A method according to claim 10, wherein said manually removing the first content item includes modifying a metadata associated with the first content item to include an indication that the first content item should be suppressed from access via the interface.

12. A method according to claim 10, wherein said manually removing the first content item includes:
restricting access to the first content item by one or more of the plurality of users that provided an indication of objection to the first content item; and
allowing access to the first content item via the interface by one or more of the plurality of users that did not provide an indication of objection to the first content item.

13. A method according to claim 1, wherein said automatically removing includes:
automatically modifying a metadata associated with the first content item to include an indication that the first content item should be suppressed from access via the interface.

14. A method according to claim 1, wherein said determining an objecting percentage includes considering only instances of access of the first content item and/or indications of objection that occur within a predetermined period of time.

15. A method according to claim 1, wherein said determining an objecting percentage includes discounting instances of access of the first content item and/or indications of objection associated with instances of access that do not involve the corresponding user accessing a minimum amount of the first content item.

16. A computer-implemented method for removing a potentially objectionable content item from distribution via a network interface, the method comprising:
providing access to a first content item via an interface over the network;
recording information corresponding to each instance of access of the first content item;
receiving one or more indications of objection to the first content item;
determining an objecting percentage of the instances of access that involve a corresponding indication of objection;
flagging the first content item for manual review when the objecting percentage meets a first threshold percentage; and
automatically removing the first content item from distribution via the interface when the objecting percentage meets a second threshold percentage and a total number of instances of access meets a third threshold number.

17. A machine-readable medium containing machine executable instructions implementing a method for removing a potentially objectionable content item from distribution via a network interface, the instructions comprising:
a set of instructions for providing an interface over the network allowing access to a first content item to a plurality of users;
a set of instructions for allowing one or more of the plurality of users to provide an indication of objection to the first content item via the interface;
a set of instructions for receiving one or more indications of objection from one or more of the plurality of users that access the first content item;
a set of instructions for determining an objecting percentage of the users that access the first content item that provide an indication of objection;
a set of instructions for flagging the first content item for manual review when the objecting percentage meets a first threshold percentage; and
a set of instructions for automatically removing the first content item from distribution via the interface when the objecting percentage meets a second threshold percentage and the total number of instances of access of the first content item meets a third threshold number.

18. A machine-readable medium according to claim 17, wherein said set of instructions for allowing one or more of the plurality of users to provide an indication of objection includes a set of instructions for providing one or more interface elements that allows a user to provide a free-form comment related to the objection.

19. A machine-readable medium according to claim 17, wherein said set of instructions for allowing one or more of the plurality of users to provide an indication of objection includes a set of instructions for providing one or more interface elements that allows a user to provide an indication of a one or more categories for the objection.

20. A machine-readable medium according to claim 17, further comprising a set of instructions for categorizing any objections received.

21. A machine-readable medium according to claim 17, wherein said set of instructions for flagging the first content item includes a set of instructions for modifying metadata associated with the first content item to indicate that the first content item should be manually reviewed.

22. A machine-readable medium according to claim 17, wherein said set of instructions for automatically removing includes a set of instructions for automatically modifying a metadata associated with the first content item to include an indication that the first content item should be suppressed from access via the interface.

23. A machine-readable medium according to claim 17, wherein said set of instructions for determining an objecting percentage includes a set of instructions for considering only instances of access of the first content item and/or indications of objection that occur within a predetermined period of time.

24. A machine-readable medium according to claim 17, wherein said set of instructions for determining an objecting percentage includes a set of instructions for discounting instances of access of the first content item and/or indications of objection associated with instances of access that do not involve the corresponding user accessing a minimum amount of the first content item.

25. A system for removing a potentially objectionable content item from distribution via a network interface, the system comprising:
means for providing an interface over the network allowing access to a first content item to a plurality of users;
means for allowing one or more of the plurality of users to provide an indication of objection to the first content item via the interface;
means for receiving one or more indications of objection from one or more of the plurality of users that access the first content item;
means for determining an objecting percentage of the users that access the first content item that provide an indication of objection;
means for flagging the first content item for manual review when the objecting percentage meets a first threshold percentage; and
means for automatically removing the first content item from distribution via the interface when the objecting percentage meets a second threshold percentage and the total number of instances of access of the first content item meets a third threshold number.

26. A computer-implemented method for removing a content item from distribution over a network, the method comprising:
providing an interface over the network allowing access to a first content item to a plurality of users;
allowing one or more of the plurality of users to provide an indication of negative feedback to the first content item via the interface;
flagging the first content item for manual review when a first threshold percentage of users that have accessed the first content item provide an indication of negative feedback to the first content item; and
automatically removing the first content item from distribution via the interface when a second threshold percentage of users that access the first content item provide the indication of negative feedback and a first threshold number of instances of access of the first content item is met.

27. A computer-implemented method for removing a content item from distribution over a network, the method comprising:
providing an interface over the network allowing access to a first content item to a plurality of users;
allowing one or more of the plurality of users to provide an indication of negative feedback to the first content item via the interface;
flagging the first content item for manual review when a first threshold percentage of users that have accessed the first content item provide an indication of negative feedback to the first content item; and
automatically removing the first content item from distribution via the interface when a second threshold percentage of users that access the first content item provide the indication of negative feedback and a first threshold number of users that access the first content item provide the indication of negative feedback.

28. A method for pulling a content item from distribution over the Internet, the method comprising:
providing an interface over the Internet allowing access to a first content item to a plurality of users;
allowing the plurality of users to provide an indication of negative feedback via the interface, the indication representing an individual user's negative reaction to the first content item;
flagging the first content item for manual review when a first percentage of users that access the first content item provide the indication of negative feedback; and
automatically removing the first content item from distribution via the interface when a second percentage of users that access the first content item provide the indication of negative feedback and a first threshold number of users that access the first content item provide the indication of negative feedback, wherein the second percentage is greater than the first percentage.
